(19) United States
(12) Patent Application Publication
(10) Pub. No.: US 2023/0180934 A1
(43) Pub. Date: Jun. 15, 2023

(54) Waterproof cementitious furniture method

(71) Applicant: Brett Thomas Martin, Tempe, AZ (US)

(72) Inventor: Brett Thomas Martin, Tempe, AZ (US)

(21) Appl. No.: 17/300,901

(22) Filed: Dec. 15, 2021

(51) Int. Cl. A47B 96/20; B32B 7/12; B32B 13/04; B32B 37/12

(52) U.S. Cl. CPC A47B 96/206; B32B 7/12; B32B 13/04; B32B 37/12; B32B 2255/26; B32B 2479/00

(57) ABSTRACT

A furniture construction method comprising cementitious sheets for a layered method of adhering various layers of cementitious board to form a solid waterproof piece of furniture with the cementitious layers. These layers of cementitious sheets form a laminate which has structural integrity to provide for vertical members of support for horizontal members comprising a piece of furniture.

A method of constructing said laminate is to apply water submersible laminating glue to cementitious board, after cutting cementitious board to desired size and cure for 6 hours. Next is to trim said laminate to final size requirements. A coat of epoxy is applied to all surfaces.

Cementitious boards are mainly cement bonded particle boards and cement fiber. There are various types of cementitious boards that are included in the present disclosure for the construction of furniture and other similar construction.

### CROSS-REFERENCE TO RELATED APPLICATIONS

Incorporated by reference is Provisional Patent U.S. 63,205,411 filed Dec. 11, 2020, by inventor and applicant Thomas S. Martin.

“Not Applicable”

### STATEMENT REGARDING FEDERALLY SPONSORED RESEARCH OR DEVELOPMENT

“Not Applicable”

### THE NAMES OF THE PARTIES TO A JOINT RESEARCH AGREEMENT

“Not Applicable”

### INCORPORATION BY REFERENCE OF MATERIAL SUBMITTED ON A COMPACT DISK OR AS A TEXT FILE VIA THE OFFICE ELECTRONIC FILING SYSTEM (EFS-WEB)

“Not Applicable”

### STATEMENT REGARDING PRIOR DISCLOSURES BY THE INVENTOR OR A JOINT INVENTOR

Incorporated by reference is Provisional Patent U.S. 63,205,411 filed Dec. 11, 2020, by inventor and applicant Thomas S. Martin.

### BACKGROUND OF THE INVENTION

### (1) Field of the Invention

This invention relates to the field of furniture construction, more particularly construction of waterproof cementitious furniture.

### (2) Description of Related Art Including Information Disclosed Under 37 CFR 1.97 and 1.98

A variety of materials and assembly methods have been used to construct furniture and related construction such as fireplace mantels, seating structures, waterproof sinks, etc. One type of construction uses concrete as construction medium. This type of construction is tedious, with the curing of the concrete a main issue to obtain a structurally solid finish. This disclosure will integrate cementitious board as a substitute to facilitate the construction of waterproof cementitious furniture and related construction.

It is an object of the present invention to provide a construction method to obtain a waterproof finished furniture piece or related construction.

It is still a further object of the present invention to provide a construction method to obtain cementitious based furniture and related construction.

### SUMMARY OF THE INVENTION

A summary of the present invention is a construction method comprising cementitious sheets for a layered method of adhering various layers of cementitious board to form a solid waterproof piece of furniture with the cementitious layers. These layers of cementitious sheets have structural integrity to provide for vertical members of support for horizontal members comprising a piece of furniture. In this disclosure the layers of cementitious sheets are disclosed as a laminate.

A method of constructing said laminate is to apply water submersible laminating glue to cementitious board, after cutting cementitious board to desired size and cure for 6 hours. Next is to trim said laminate to final size requirements. A next step is to attach material for a front drop edge comprised of cementitious boards, attaching at bottom a minimum of ⅛ inch above surface to contain epoxy flow. Further, apply adhesive to seam at intersection of top of counter and drop edge to avoid seepage by epoxy. Next, apply a first application of epoxy and allow to cure. Further, flush trim drop edge to first layer of epoxy. Next apply final layer of epoxy overlapping top edge of drop edge material.

Cementitious boards are mainly cement bonded particle boards and cement fiber. There are various types of cementitious boards that are included in the present disclosure for the construction of furniture, sinks, fireplace mantels and other similar construction.

### BRIEF DESCRIPTION OF THE DRAWINGS

FIG. 1 is an isometric drawing of the laminate 10 used throughout the various construction of the following FIGS. 1 through FIG. 8. Shown in FIG. 1 is a bottom cementitious board 5 adhered to a center cementitious board 5 and a top cementitious board 5, said boards are adhered by laminating glue 3. On the surface of said top cementitious board 5 is a layer of epoxy 2.

FIG. 2 is a table 20 comprising a plurality of cementitious board 5, said boards are adhered by laminating glue 3 as shown in FIG. 1. On the surface of said top cementitious board 5 is a first layer of epoxy 2 and a further second layer of epoxy 2 on top of the first epoxy layer 2 as shown in FIG. 1. A base is shown formed of cementitious board 5 and a supporting member also formed of cementitious board 5.

FIG. 3 is a table 30 with an oval top formed by cementitious board 5, a supporting member formed of cementitious board 5 and a base formed of cementitious board 5. The oval top, supporting member, and base are coated with epoxy 2 as shown in FIG. 1.

FIG. 4 is a dinner table 40 comprising supports formed from laminate 10 as shown in FIG. 1 which support a table top also formed of laminate 10, said supports and tabletop are coated with epoxy 2 as shown in FIG. 1.

FIG. 5 is a bench 50 comprising supports formed of laminate 10, a seat also formed of laminate 10 and a back also formed of laminate 10, said supports, seat, and back are coated with epoxy 2, as shown in FIG. 1.

FIG. 6 is an outdoor barbeque table 60 with supports formed of laminate 10 and a top base also formed of laminate 10. Said top base can be cut out to insert a barbeque grill, either square as shown or circular to fit common grills. Said laminate 10 is formed of cementitious board 5 as shown in FIG. 1 and coated with epoxy 2, also shown in FIG. 1. Cementitious board 5 is fire-proof from the non-combustible properties of cementitious board 5.

FIG. 7 is a desk 70 comprising supports formed of laminate 10 with a top also formed of laminate 10 and a back also formed of laminate 10. Said supports, top, and back are coated with epoxy 2 as shown in FIG. 1.

FIG. 8 is a cabinet 80 comprising supports formed of laminate 10 comprised of a plurality of cementitious board 5 as shown in FIG. 1. Said cabinet has a top surface and back cabinet compartments also formed of laminate 10. Said supports, top surface, and cabinet compartments are coated with epoxy 2 as shown in FIG. 1.

### DETAILED DESCRIPTION OF THE INVENTION

Incorporated by reference is Provisional Patent U.S. 63,205,411 filed Dec. 11, 2020, by inventor and applicant Thomas S. Martin.

Presented in this disclosure is of the present invention is a construction method comprising cementitious sheets for a layered method of adhering various layers of cementitious board to form a solid waterproof piece of furniture with the cementitious layers. These layers of cementitious sheets have structural integrity to provide for vertical members of support for horizontal members comprising a piece of furniture.

Cementitious boards are mainly cement bonded particle boards and cement fiber. There are various types of cementitious boards that are included in the present disclosure for the construction of furniture, sinks, fireplace mantels and other similar construction.

One such cementitious board are cement bonded particle boards that have treated wood flakes as reinforcement, whereas in cement fiber boards have cellulose fiber, which is a plant extract as reinforcement. Cement acts as a binder in both cases. The fire resistance properties of cement bonded blue particle boards and cement fiber boards are the same. In terms of load bearing capacity, cement bonded particle boards have higher capacity than cement fiber boards. Cement particle boards are manufactured from ¼ to 1 9/16 inches in thickness making it suitable for high load bearing applications.

In this disclosure the application of cementitious board for furniture construction will vary as to required strength of the furniture members.

The cementitious boards disclosed in this invention are made of a homogeneous mixture and hence are formed as single layer for selected thickness. Cement fiber boards are more used in decorative furniture and can be manufactured from ⅛ to 13/16 thickness. Fiber boards are made in very thin layers, making it adaptable for varying furniture piece members. Manufacturers use additives like mica, aluminum stearate and other additives to achieve certain board qualities. Typical cement fiber board is made of approximately 40-60% of cement, 20-30% of fillers, 8-10% of cellulose, 10-15% of mica. Other additives like above mentioned aluminum stearate and PVA are normally used in quantities less than 1%.

Cement board has long term performance as it will not allow mildew or physically break down in the continued presence of moisture or leaks. This makes cementitious board used in the present disclosure ideal for sinks and other areas around the presence of water.

There is a class of cement board strictly constructed of a Portland cement-based core with glass fiber mat reinforcing both faces. These panels can be immersed in water without any degradation. These panels do not require the sealing of edges and penetrations to maintain their structural integrity. These Portland cement-based boards are smaller in size compared with other cementitious boards.

Cement board is a combination of cement and reinforcing fibers formed into sheets, of varying thickness that are typically used as a tile backing board. Cement board can be nailed or screwed to wood or steel studs to create a substrate for vertical tile and attached horizontally to plywood for tile floors, kitchen counters.

Cement board adds impact resistance and strength to a surface as compared to gypsum board or other construction boards. Cement board is also fabricated in thin sheets with polymer modified cements to allow bending for curved surfaces.

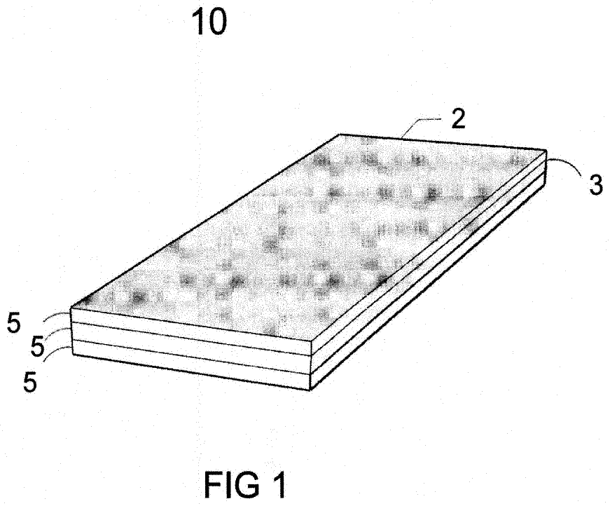

Presented in this disclosure is of the present invention is a construction method comprising cementitious sheets for a layered method of adhering various layers of cementitious board to form a solid waterproof piece of furniture with the cementitious layers. These layers of cementitious sheets have structural integrity to provide for vertical members of support for horizontal members comprising a piece of furniture. FIG. 1 is an isometric drawing of the laminate 10 used throughout the various construction of the following FIGS. 1 through FIG. 8. Shown in FIG. 1 is a bottom cementitious board 5 adhered to a top cementitious board 5, said boards are adhered by laminating glue 3. On the surface of said top cementitious board 5 is a layer of epoxy 2.

A method of constructing the laminate 10 of FIG. 1 is to apply water submersible laminating glue 3 to cementitious board 5, after cutting cementitious board 5 to desired sizes and cure for 6 hours. Next is to trim laminate 10 to final size requirements.

Turning now to the drawings, FIG. 1 is an isometric drawing of the laminate 10 used throughout the various construction of the following FIGS. 1 through FIG. 8. Shown in FIG. 1 is a bottom cementitious board 5 adhered to a top cementitious board 5, said boards are adhered by laminating glue 3. On the surface of said top cementitious board 7 is a layer of epoxy 2.

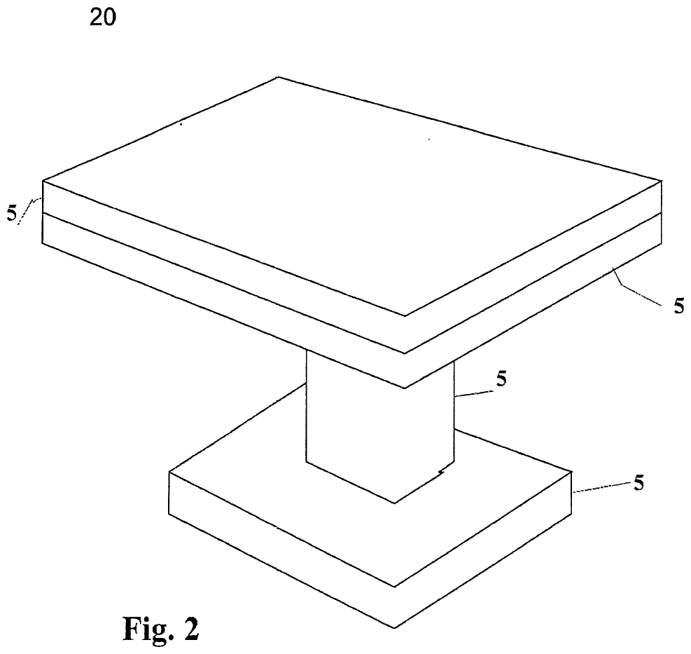

FIG. 2 is a table 20 comprising a plurality of cementitious board 5, said boards are adhered by laminating glue 3 as shown in FIG. 1. On the surface of said top cementitious board 5 is a layer of epoxy 2 as shown in FIG. 1. A base is shown formed of cementitious board 5 and a supporting member also formed of cementitious board 5.

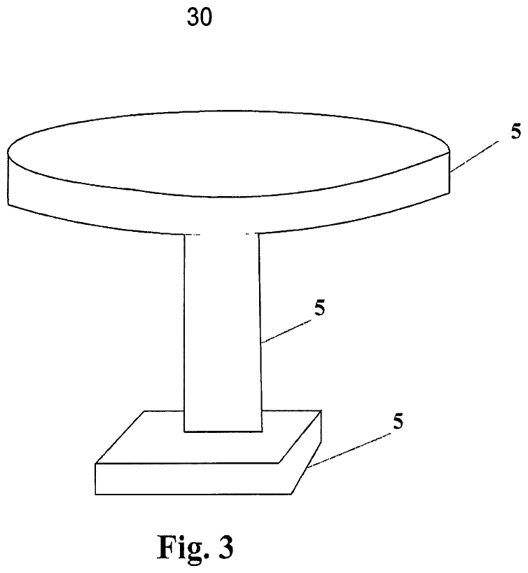

FIG. 3 is a table 30 with an oval top formed by cementitious board 5, a supporting member formed of cementitious board 5 and a base formed of cementitious board 5. The oval top, supporting member, and base are coated with epoxy 2 as shown in FIG. 1.

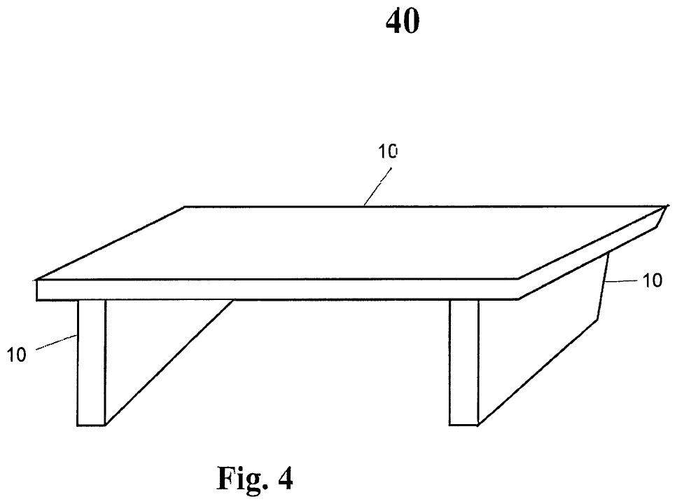

FIG. 4 is a dinner table 40 comprising supports formed from laminate 10 as shown in FIG. 1 which support a table top also formed of laminate 10, said supports and tabletop horizontal laminate are coated with epoxy 2 as shown in FIG. 1.

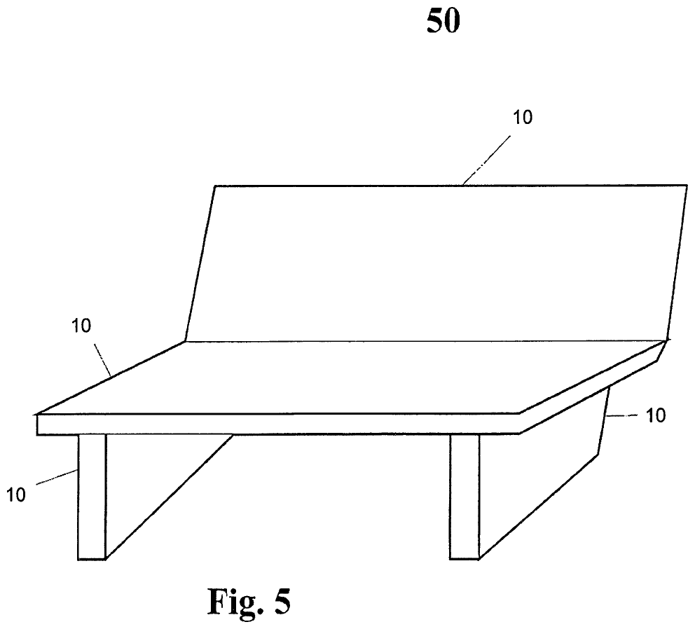

FIG. 5 is a bench 50 comprising supports formed of laminate 10, a seat also formed of laminate 10 and a back also formed of laminate 10, said supports, seat, and back are coated with epoxy 2, as shown in FIG. 1.

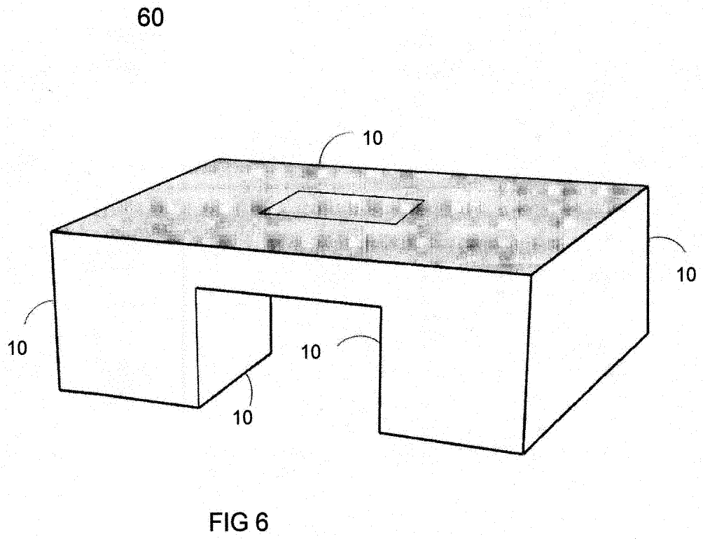

FIG. 6 is an outdoor barbeque table 60 with supports formed of laminate 10 and a top base also formed of laminate 10. Said top base can be cut out to insert a barbeque grill, either square as shown or circular to fit common grills. Said laminate 10 is formed of cementitious board 5 as shown in FIG. 1 and coated with epoxy 2, also shown in FIG. 1. Cementitious board 5 is fire-proof from the non-combustible properties of cementitious board 5.

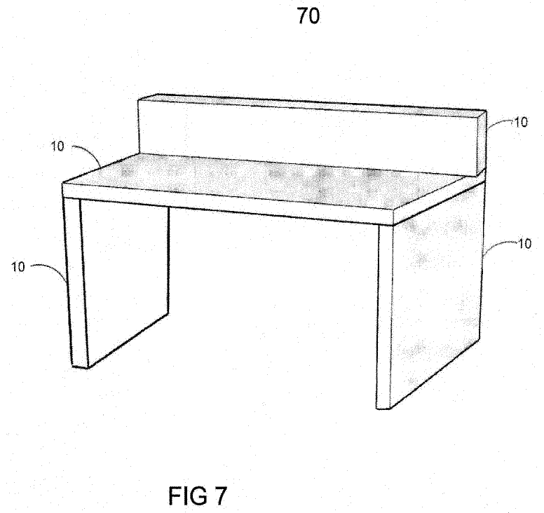

FIG. 7 is a desk 70 comprising supports formed of laminate 10 with a top also formed of laminate 10 and a back also formed of laminate 10. Said supports, top, and back are coated with epoxy 2 as shown in FIG. 1.

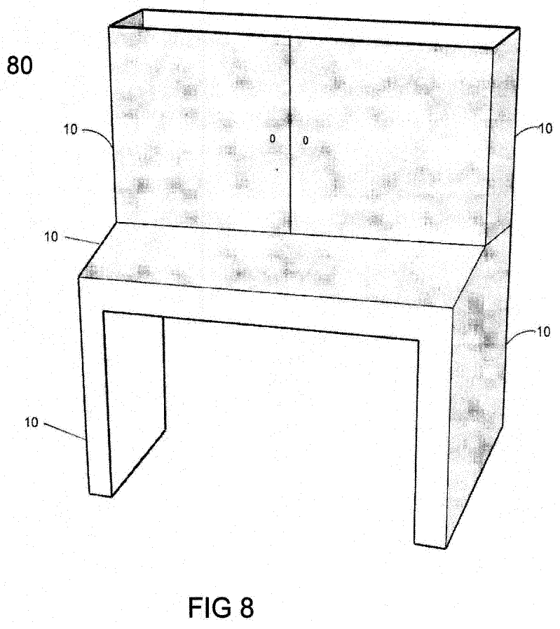

FIG. 8 is a cabinet 80 comprising supports formed of laminate 10 comprised of a plurality of cementitious board 5 as shown in FIG. 1. Said cabinet has a top surface and back cabinet compartments also formed of laminate 10. Said supports, top surface, and cabinet compartments are coated with epoxy 2 as shown in FIG. 1.

What is claimed is:

1. A furniture construction method comprising cementitious sheets for a layered method of adhering various layers of cementitious board to form a solid waterproof piece of furniture with the cementitious layers, said layers of cementitious sheets form a laminate which has structural integrity to provide for vertical members of support for laminate horizontal members, both members comprising a piece of furniture, said method comprises the following steps:
select cementitious board;
adhere cementitious board with adhesive to form a laminate;
form supporting laminate for vertical members;
form laminate for horizontal members;
adhere vertical members to horizontal members; and
coat finished assembly of vertical and horizontal members.

2. A furniture construction method as in claim 1 wherein selecting cementitious board for a particular piece of furniture comprises selecting from a class of cement board strictly constructed of a Portland cement-based core with glass fiber mat reinforcing both faces, or cementitious board which is a combination of cement and reinforcing fibers formed into sheets, or cement board which is fabricated in thin sheets with polymer modified cements to allow bending for curved surfaces.

3. A furniture construction method as in claim 1 wherein adhering cementitious board to form a laminate comprises applying water submersible laminating glue to cementitious board and cure for 6 hours.

4. A furniture construction method as in claim 3 wherein forming of supporting laminate for vertical supporting members comprises determination of desired vertical strength of said vertical supporting members and adhering a plurality of cementitious board to attain said desired vertical strength.

5. A furniture construction method as in claim 4 wherein forming laminate for horizontal members comprised determination of desired horizontal strength of said horizontal members to support weight of said horizontal members and additional weight which may be applied to said horizontal members, thereby adhering a plurality of cementitious board to attain said desired horizontal strength.

6. A furniture construction method as in claim 5 wherein adhering said horizontal members to said vertical members comprises applying adhesive, brackets and screws, and hardware to join said horizontal and vertical members.

7. A furniture construction method as in claim 6 wherein coating said finished assembly of said horizontal and vertical members comprises applying epoxy in a plurality of layers to achieve a durable finished assembly.
